(19) United States
(12) Patent Application Publication
(10) Pub. No.: US 2008/0320165 A1
(43) Pub. Date: Dec. 25, 2008

(54) Method for Supporting Ipv6 Neighbor Discovery in Point-To-Point Oriented Broadband Wireless Network

(75) Inventors: Hong Seok Jeon, Daejeon-city (KR); Jung Hoon Jee, Daejeon-city (KR); Jong Hwa Yi, Daejeon-city (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics & Telecommunications Research Institut, Daejeon (KR)

(21) Appl. No.: 12/090,346

(22) PCT Filed: Oct. 13, 2006
(86) PCT No.: PCT/KR2006/004116

§ 371 Date: Apr. 15, 2008

(30) Foreign Application Priority Data
Oct. 15, 2005 (KR) 10 2005 0097263
Dec. 15, 2005 (KR) 10 2005 0124054

(51) Int. Cl. G06F 15/16

(52) U.S. Cl. 709/242

(57) ABSTRACT

Provided are a method and system for supporting IPv6 Neighbor Discovery in a point-to-point oriented broadband wireless network. The method includes: an access router in the broadband wireless network receiving a message from a first subscriber station in the broadband wireless network; the access router detecting a Neighbor Discovery message from the received message; and the access router relaying the Neighbor Discovery message to a second subscriber station in the broadband wireless network. The method can support IPv6 Neighbor Discovery where hosts in the point-to-point oriented broadband wireless network share one or multiple prefixes.

This application claims the benefit of Korean Patent Application Nos. 10-2005-0097263, filed on Oct. 15, 2005 and 10-2005-0124054, filed on Dec. 15, 2005, in the Korean Intellectual Property Office, the disclosures of which are incorporated herein in its entirety by reference.

### TECHNICAL FIELD

The present invention relates to a method for supporting Internet Protocol version 6 (IPv6) Neighbor Discovery, and more particularly, to a method and system for supporting IPv6 Neighbor Discovery in a point-to-point oriented broadband wireless network. The proposed method can transmit IPv6 Neighbor Discovery messages and support multicast transmission of the messages where hosts in the point-to-point oriented broadband wireless network share one or multiple prefixes.

### BACKGROUND ART

‘Multicast in Point-to-Point Packet-switched oriented Network’ disclosed in U.S. Patents and Trademark Office (2004-0233907) relates to a tunnel for multicast data transmission, the tunnel formed between an Internet Protocol (IP) router (i.e., gateway GPRS support node, GGSN) and a serving node in a telecommunication network (i.e., service GPRS support node, SGSN) to provide a multicast service in a point-to-point oriented telecommunication network. The current invention is effective in providing a method of generating a multicast tree in a point-to-point oriented network.

‘Method and System for Initiating Multicast Service in Telecommunication System’ (2005-0009774) disclosed in the Korean Intellectual Property Office relates to a method and system for notifying a multicast service in a cellular phone system, the cellular phone system providing both multicast and point-to-point service. According to the method, an access network distributes a channel for multicast service transmission between the access network and a subscriber station using a signaling conversation between subscriber stations that belong to the access network and a multicast group.

### DISCLOSURE OF INVENTION

### Technical Problem

‘Recommendations for IPv6 in Third Generation Partnership Project (3GPP) Standards (RFC 3314)’, which is a IETP document, discloses a method of solving problems caused while IPv6 is operating, by providing characteristic network prefix information to each subscriber station receiving a service under a base station. However, the present invention assumes that all subscriber stations under a base station have the same network prefix information.

### Technical Solution

The present invention provides a method and system for supporting Internet Protocol version 6 (IPv6) Neighbor Discovery in a point-to-point oriented broadband wireless network. The proposed method can transmit IPv6 Neighbor Discovery messages and support multicast transmission of the messages where hosts in the point-to-point broadband wireless network share one or multiple prefixes.

According to an aspect of the present invention, there is provided a method of supporting Internet Protocol version 6 (IPv6) Neighbor Discovery in a broadband wireless network having a point-to-point link between a subscriber station and a base station, the method including: an access router in the broadband wireless network receiving messages from a first subscriber station in the broadband wireless network; the access router detecting IPv6 Neighbor Discovery messages from the received messages; and the access router relaying the IPv6 Neighbor Discovery messages to a second subscriber station in the broadband wireless network.

According to another aspect of the present invention, there is provided a method of supporting IPv6 Neighbor Discovery in a broadband wireless network having a point-to-point link between a subscriber station and a base station, the method including: a base station in the broadband wireless network receiving messages from a first subscriber station in the broadband wireless network; the base station detecting IPv6 Neighbor Discovery messages from the received messages; and the base station relaying the IPv6 Neighbor Discovery messages to a second subscriber station in the broadband wireless network.

### ADVANTAGEOUS EFFECTS

According to the present invention, an IPv6 Neighbor Discovery protocol can be used without any problem where hosts in a point-to-point oriented broadband wireless network share one or multiple prefixes, such as WiMax, WiBro, IEEE 802.16(e). According to the present invention, a conventional IPv6 Neighbor Discovery method is not required to be modified. Also, the present invention provides a multicast service in a broadband wireless network where a multicast service of IP data is not provided. In addition, not only IPv6 Neighbor Discovery is possible, but also transmitting data having another link-local scope multicast address as a destination address is possible in a broadband wireless network.

### DESCRIPTION OF DRAWINGS

The above and other features and advantages of the present invention will become more apparent by describing in detail exemplary embodiments thereof with reference to the attached drawings in which:

FIG. 1 is a diagram illustrating a structure of a broadband wireless network according to an embodiment of the present invention, wherein a network subnet consists of an access router and a plurality of base stations;

FIG. 2 is a diagram illustrating a structure of a broadband wireless network according to another embodiment of the present invention, wherein a network subnet consists of an access router and a single base station;

FIG. 3 is a diagram for explaining a method and system for supporting IPv6 Neighbor Discovery in a point-to-point oriented broadband wireless network using a MEP-CCID according to an embodiment of the present invention; and

FIG. 4 is a diagram for explaining a method and system for supporting IPv6 Neighbor Discovery in a point-to-point oriented broadband wireless network using a MEP-MU according to another embodiment of the present invention.

### MODE FOR INVENTION

Hereinafter, the present invention will be described more fully with reference to the accompanying drawings, in which exemplary embodiments of the invention are shown.

The present invention relates to structures and methods for supporting a conventional Internet Protocol version 6 (IPv6) Neighbor Discovery transmission where hosts in a point-to-point oriented broadband wireless network share one or multiple prefixes.

In a point-to-point oriented broadband wireless network, a base station (hereinafter, referred to as ‘BS’) and a subscriber station (hereinafter, referred to as ‘SS’) are connected by point-to-point link. The point-to-point link limits an IPv6 Neighbor Discovery message from one SS to be transmitted directly to other SSs. In other words, an access router (hereinafter, referred to as ‘AR’) is the only neighboring IP node of the each SS. On the other hand, IPv6 determines neighboring IP node by performing a longest prefix match against the assigned prefix list. Accordingly, when SSs under an AR share same prefix, all the SSs can be neighboring hosts to each other. Due to the different definitions of a neighboring host as described above, problems may occur while transmitting IPv6 Neighbor Discovery messages to neighboring hosts.

According to an embodiment of the present invention, IPv6 Neighbor Discovery messages are relayed by AR (or BS) in order to be transmitted to neighboring SSs and multicast transmission of the IPv6 Neighbor Discovery messages is emulated by setting up a common connection to all SSs or repeatedly unicasting.

A method of relaying IPv6 Neighbor Discovery messages according to an embodiment of the present invention is to define a Multicast Relay Part (hereinafter, referred to as ‘MRP’) in order to receive IPv6 Neighbor Discovery messages and forward the IPv6 Neighbor Discovery messages.

Data to be relayed by MRP are IPv6 Neighbor Discovery messages having a link-local scope multicast address as the destination address. Accordingly, a method of selecting the IPv6 Neighbor Discovery messages is required. In the current embodiment of the present invention, the selecting methods in case of IPv6 over Ethernet and IPv6 are as follows. First, when IPv6 over Ethernet is supported in a broadband wireless network, data having an Ethernet destination address which starts with ‘33-33’ are selected in order to be relayed. Second, when only IPv6 is supported in a broadband wireless network, data having an IPv6 destination address which starts with ‘FF02’ are selected in order to be relayed. However, data having ‘FF02::2’ as an IPv6 destination address or ‘33-33-00-00-00-03’ as an Ethernet destination address are excluded since the data are destined to a router, not SSs.

A method of transmitting link-local scope multicast IP data including IPv6 Neighbor Discovery messages in a point-to-point oriented broadband wireless network according to an embodiment of the present invention is to define a Multicast Emulation Part (hereinafter, referred to as ‘MEP’) in order to transmit multicast data in the wireless network. Examples of the method include a MEP-Common Connection ID (hereinafter, referred to as ‘MEP-CCID’) method which the MEP assigns a special connection ID (hereinafter, referred to as ‘CID’) for the link-local scope multicast data and a MEP-Multi Unicast (hereinafter, referred to as ‘MEP-MU’) method which uses replicated unicast.

In the MEP-CCID method, a special CID is assigned for the link-local scope multicast data transmission. All SSs under a same BS generate the special CID in common, thereby called a common CID (CCID). Data transmitted via the CCID can be received by all SSs. To generate CCID, a MEP-CCID function is added on the BS and the SS. In case of IEEE 802.16e network, a CCID generating method may use the same method of generating MBS-CID.

When mapping a CCID and an IPv6 Neighbor Discovery message relayed by a MRP on an AR (or a BS), data having an Ethernet destination address starting with ‘33-33’ when IPv6 over Ethernet is supported in a broadband wireless network or data having an IPv6 destination address starting with ‘FF02’ when only IPv6 is supported in a broadband wireless network are mapped with the CCID. The mapping information can be generated while generating the CCID.

Using the MEP-MU method, an IPv6 Neighbor Discovery message is transmitted to corresponding SSs using replicated unicast. It can be achieved by managing information on SSs which need to receive the IPv6 Neighbor Discovery message. The MEP-MU method of transmitting an IPv6 Neighbor Discovery message includes the following processes. First, an MEP-MU on the SS generates a its own solicited-node multicast address using the last 24 bits of its own interface identifier (IEEE EUI-64 address). Seconds, the MEP-MU on the SS transmits the information on the generated solicited-node multicast address and its own link-local address to a MEP-MU on the AR. Here, the link-local address of the SS is an address not yet proven to be unique by a Duplicate Address Detection (hereinafter, referred to as ‘DAD’) method. Third, the MEP-MU on the AR manages a table mapping the solicited-node multicast address and the corresponding link-local address based on the received information. The uniqueness of the link-local address can be proved using the table without performing the DAD method. If the link-local address is not unique, following processes are not performed. Fourth, the MRP on the AR determines an IPv6 Neighbor Discovery message that is to be relayed. Then the MRP on the AR transmits the IPv6 Neighbor Discovery message to all SSs by replicated unicast after changing an IP destination address of the IPv6 Neighbor Discovery message to a link-local address of each SSs based on the table when the IP destination address is a link-local all node multicast address. Also, when the IP destination address is a solicited-node multicast address, a link-local address of the solicited-node multicast address is searched using the table. Then the IP destination address is changed to the searched link-local address in order to transmit the IPv6 Neighbor Discovery message to corresponding SSs by replicated unicast.

Accordingly, a conventional IPv6 Neighbor Discovery message transmission can be performed where hosts in the point-to-point oriented broadband wireless network share one or multiple prefixes.

FIG. 1 is a diagram illustrating a structure of a broadband wireless network according to an embodiment of the present invention, wherein an AR locates several BSs into the same network subnet. Referring to FIG. 1, an MRP in the AR receives an IPv6 Neighbor Discovery message from a SS and relays the IPv6 Neighbor Discovery message to other SSs through each BS.

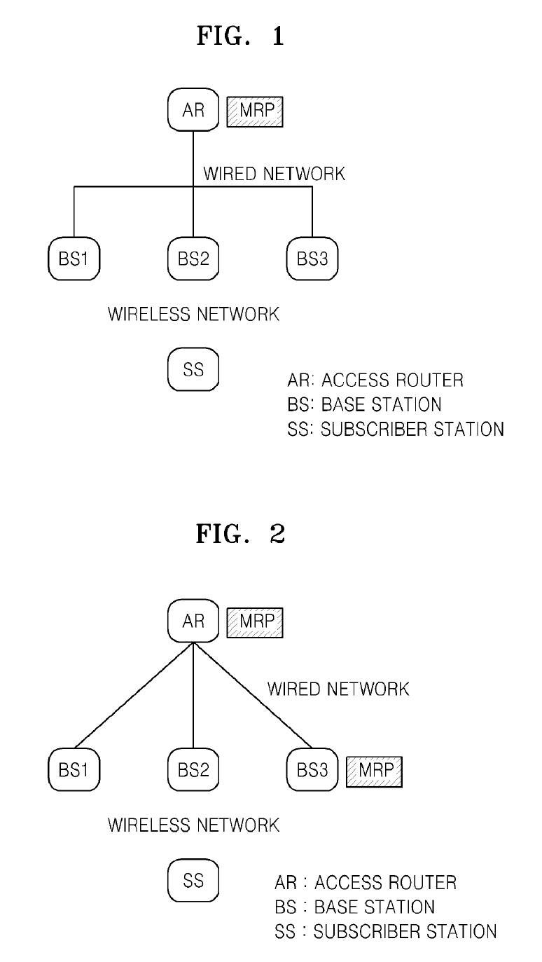

FIG. 2 is a diagram illustrating a structure of a broadband wireless network according to another embodiment of the present invention, wherein an AR locates each BS into a separate network subnet. Referring to FIG. 2, an MRP in the AR or BS receives an IPv6 Neighbor Discovery message from a SS and relays the IPv6 Neighbor Discovery message to other SSs under the same BS.

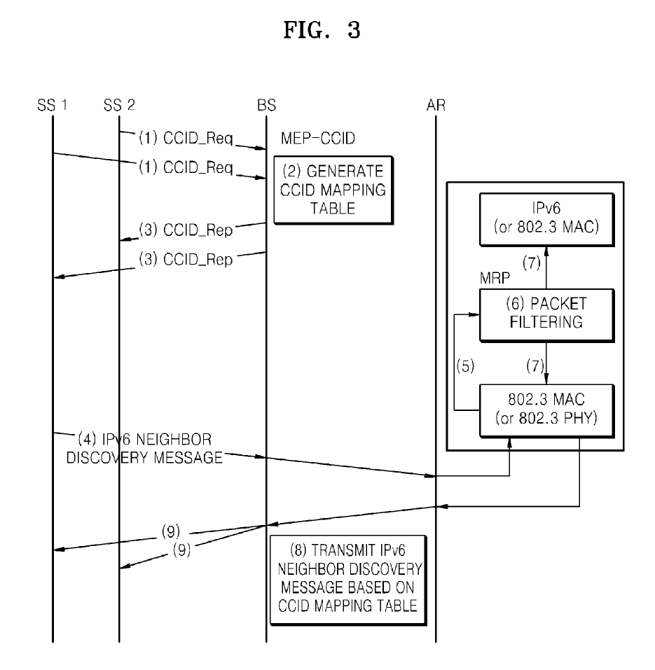

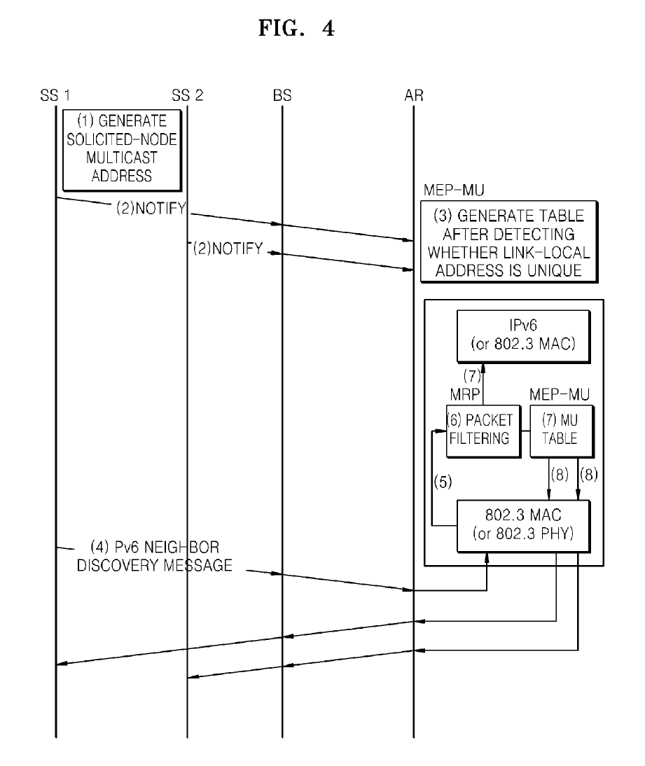

FIG. 3 is a diagram for explaining a method and system for supporting IPv6 Neighbor Discovery in a point-to-point oriented broadband wireless network using a MEP-CCID according to an embodiment of the present invention. In FIG. 3, there are two SSs, i.e. SS1 and SS2, and an AR including an MRP.

Referring to FIG. 3, MEP-CCIDs on SS1 and SS2 send a message (CCID_Req message) to a BS in order to request a CCID in operation 1. A MEP-CCID on the BS generates a CCID mapping table after receiving the CCID_Req message in operation 2. When IPv6 over Ethernet is supported in a broadband wireless network, the CCID mapping table has mapping information of data having an Ethernet destination address starting with ‘33-33’ and the CCID. When only IPv6 is supported in a broadband wireless network, the CCID mapping table has mapping information of data having an IPv6 destination address starting with ‘FF02’ and the CCID. After the CCID mapping table is generated, the MEP-CCID of the BS sends a reply (CCID_Rep message) to SS1 and SS2 to assign the CCID in operation 3. The CCID may be assigned by BS without the CCID_Req message from SS. When SS1 sends an IPv6 Neighbor Discovery message, the IPv6 Neighbor Discovery message is transmitted to the AR through the BS in operation 4. The transmitted IPv6 Neighbor Discovery message arriving at the lower layer of the AR is provided to an MRP of the AR before being transmitted to the IPv6 layer of the AR in operation 5. The MRP of the AR selects data to be relayed among data coming from the lower layer in operation 6. Data that needs to be relayed among the data coming from the lower layer are an IPv6 Neighbor Discovery messages having a link-local scope multicast address as a destination address. There are two cases in selecting data. First, when IPv6 over Ethernet is supported in a broadband wireless network, data having an Ethernet destination address which starts with ‘33-33’ are selected in order to be relayed. Second, when only IPv6 is supported in a broadband wireless network, data having an IPv6 destination address which starts with ‘FF02’ are selected in order to be relayed. However, data having ‘FF02::2’ as an IPv6 destination address or ‘33-33-00-00-00-03’ as an Ethernet destination address are excluded since the data are destined to a router. The MRP of the AR delivers the data to the IPv6 layer and at the same time, copies the data in order to forward the data to the network in operation 7. The copied IPv6 Neighbor Discovery messages are transmitted through the CCID by referring the CCID mapping table in operation 8. Accordingly, all SSs allotted with the CCID receive the IPv6 Neighbor Discovery message in operation 9.

FIG. 4 is a diagram for explaining a method and system for supporting IPv6 Neighbor Discovery in a point-to-point oriented broadband wireless network using a MEP-MU according to another embodiment of the present invention. In FIG. 4, there are two SSs, i.e. SS1 and SS2, and an AR including an MRP.

Referring to FIG. 4, MEP-MUs on SS1 and SS2 generate their own solicited-node multicast addresses using the last 24 bits from their own interface identifier (IEEE EUI-64 address) in operation 1. The MEP-MUs on SS1 and SS2 transmit the information on the generated solicited-node multicast addresses and their own link-local addresses to an MEP-MU on the AR through a notify message in operation 2. Here, the link-local addresses are addresses not yet proven to be unique using a DAD method. The MEP-MU on the AR manages a table mapping the solicited-node multicast address and the corresponding link-local address based on the received information in operation 3. The uniqueness of the link-local address can be proved using the table without performing the DAD method. If the link-local address is not unique, the following operations are not performed. When the SS1 sends an IPv6 Neighbor Discovery message, the IPv6 Neighbor Discovery message is transmitted to the AR through the BS in operation 4. The transmitted IPv6 Neighbor Discovery message arriving at the lower layer of the AR is provided to an MRP of the AR before being transmitted to the IPv6 layer of the AR in operation 5. The MRP of the AR selects data to be relayed among data coming from the lower layer in operation 6. Data that needs to be relayed among data coming from the lower layer are IPv6 Neighbor Discovery messages having a link-local scope multicast address as a destination address. There are two cases in selecting data. First, when IPv6 over Ethernet is supported in a broadband wireless network, data having an Ethernet destination address which starts with ‘33-33’ are selected in order to be relayed. Second, when only IPv6 is supported in a broadband wireless network, data having an IPv6 destination address which starts with ‘FF02’ are selected in order to be relayed. However, data having ‘FF02::2’ as an IPv6 destination address or ‘33-33-00-00-00-03’ as an Ethernet destination address are excluded since the data are destined to a router. The MRP of the AR delivers the data to the IPv6 layer of the AR and at the same time, copies the data in order to forward the data to the MEP-MU of the AR in operation 7. When an IP destination address of the IPv6 Neighbor Discovery message is a link-local all node multicast address, the IP destination address is changed to the link-local address of each SSs based on the table. When an IP destination address of the IPv6 Neighbor Discovery message is the solicited-node multicast address, a link-local address of the corresponding solicited-node multicast address is searched using the table, and then the IP destination address is changed to the searched link-local address. The IPv6 Neighbor Discovery message with the changed IP destination address is transmitted to SS1 and SS2 by replicated unicast in operation 8.

Although FIGS. 3 and 4 are described when an MRP is in an AR, it is well known to one of ordinary skill in the art that a multicast transmission when an MRP is in a BS can be applied referring to FIGS. 3 and 4. Accordingly, detailed descriptions thereof will be omitted.

The present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments which embody the present invention are obvious to programmers in the related art.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of supporting Internet Protocol version 6 (IPv6) Neighbor Discovery in a broadband wireless network having a point-to-point link between a subscriber station and a base station, the method comprising:
an access router in the broadband wireless network receiving a message from a first subscriber station in the broadband wireless network;
the access router detecting a Neighbor Discovery message from the received message; and
the access router relaying the Neighbor Discovery message to a second subscriber station in the broadband wireless network.

2. The method of claim 1, wherein, in the detecting of a Neighbor Discovery message, the Neighbor Discovery message is detected after determining whether a layer 2 address (or IPv6 address) of the received message corresponds to a predetermined address.

3. The method of claim 1, wherein the relaying of the Neighbor Discovery message is performed by emulating multicast transmission in the broadband wireless network.

4. The method of claim 3, further comprising:
the base station generating a table which maps a common connection identifier and a predetermined address, before the access router receives a message; and
the base station allotting the common connection identifier to all subscriber stations in the broadband wireless network,
wherein the relaying of the Neighbor Discovery message comprises:
the access router delivering the detected Neighbor Discovery message to an IPv6 layer of the access router and forwarding the detected Neighbor Discovery message to the broadband wireless network; and
the base station, which has received the Neighbor Discovery message from the access router, transmitting the Neighbor Discovery message to the second subscriber station through the common connection identifier, by referring the generated mapping table.

5. The method of claim 1, wherein, in the relaying of the Neighbor Discovery message, the Neighbor Discovery message is transmitted to the second subscriber station, where the detected Neighbor Discovery message is to be relayed, using replicated unicast.

6. The method of claim 5, further comprising:
each subscriber station in the broadband wireless network generating a solicited-node multicast address before the access router receives a message;
each subscriber station transmitting the information on the generated solicited-node multicast address and its own link-local address to the access router; and
the access router generating a table which maps the solicited-node multicast address and the link-local address based on the transmitted information,
wherein the relaying of the Neighbor Discovery message comprises:
the access router delivering the detected Neighbor Discovery message to the IPv6 layer of the access router and forwarding the detected Neighbor Discovery message to the broadband wireless network; and
the access router transmitting the Neighbor Discovery message to the second subscriber station in the broadband wireless network using replicated unicast after changing the IP destination address of the copied Neighbor Discovery message based on the generated table.

7. The method of claim 6, wherein, in the changing of the IP destination address, the IP destination address is changed to the link-local addresses of each subscriber stations based on the generated mapping table and the IPv6 Neighbor Discovery message is transmitted to all subscriber stations using replicated unicast with the changed IP destination addresses, when the IP destination address of the Neighbor Discovery message is a link-local all node multicast address.

8. The method of claim 6, wherein the changing of the IP destination address comprises:
when the IP destination address of the Neighbor Discovery message is the solicited-node multicast address, obtaining link-local addresses of the corresponding subscriber stations based on the generated mapping table; and
changing the IP destination address of the Neighbor Discovery message to the obtained link-local addresses and forwarding the Neighbor Discovery message with the changed IP destination address to the second subscriber stations using replicated unicast.

9. A method of supporting IPv6 Neighbor Discovery in a broadband wireless network having a point-to-point characteristic between a subscriber station and a base station, the method comprising:
a base station in the broadband wireless network receiving a message from a first subscriber station in the broadband wireless network;
the base station detecting a Neighbor Discovery message from the received message; and
the base station relaying the Neighbor Discovery message to a second subscriber station in the broadband wireless network.

10. The method of claim 9, wherein, in the detecting a Neighbor Discovery message, the Neighbor Discovery message is detected after determining whether a layer 2 address (or IPv6 address) of the received message corresponds to a predetermined address.

11. The method of claim 9, wherein the relaying the Neighbor Discovery message is performed using a multicast connection in the broadband wireless network.

12. The method of claim 11, wherein the base station sends the detected Neighbor Discovery message to an access router and forwards the detected Neighbor Discovery message to the broadband wireless network, wherein before the base station transmits the copied Neighbor Discovery message to the broadband wireless network, the base station assigns a common connection identifier to all subscriber stations in the broadband wireless network, generates a table which maps the common connection identifier and a predetermined address, and transmits the Neighbor Discovery message received from the access router to the second subscriber station through the common connection identifier, by referring the generated mapping table.

13. The method of claim 9, wherein the relaying the Neighbor Discovery message comprises transmitting the Neighbor Discovery message to the second subscriber station, where the detected Neighbor Discovery message is to be relayed, using replicated unicast.

14. The method of claim 13, wherein the second subscriber station in the broadband wireless network generates a solicited-node multicast address and transmits the information on the generated solicited-node multicast address and its own link-local address to the base station, and the base station generates a table which maps the solicited-node multicast address and the link-local address based on the received information, changes the IP destination address of the detected Neighbor Discovery message to corresponding link-local address by referring the generated table, and forwards the Neighbor Discovery message with the changed IP destination address to the second subscriber station in the broadband wireless network using replicated unicast while transmitting the Neighbor Discovery message to the access router.

15. A computer readable recording medium, having a program recorded thereon for performing the method of claim 1.
